(19) United States
(12) Patent Application Publication
(10) Pub. No.: US 2011/0243673 A1
(43) Pub. Date: Oct. 6, 2011

(54) RETRACTABLE DRILL BIT APPARATUS, SYSTEM, AND METHOD

(76) Inventor: Bohus Svagr, Morgan, UT (US)

(21) Appl. No.: 12/753,710

(22) Filed: Apr. 2, 2010

(51) Int. Cl. B23B 47/20; B23B 35/00

(52) U.S. Cl. 408/1 R; 408/9; 408/146

(57) ABSTRACT

An apparatus, system, and method are disclosed for retracting a drill bit relative to a drill. In one embodiment, the apparatus includes a driving device within the drill, a drill bit coupleable to the driving device, a first engaging element coupled to the drill bit, a sensor in communication with the driving device, and a second engaging element coupled to the drill. The drill bit is rotatably drivable by the driving device. The sensor detects a change in a speed of the drill bit. The second engaging element engages with the first engaging element in response to the sensor detecting a change in the speed of the drill bit. The drill bit retracts relative to the drill in response to engagement between the second engaging element and the first engaging element.

### FIELD

The present disclosure relates to drills and associated drill bits for drilling a material, and more particularly to a drill having a retractable drill bit.

### BACKGROUND

Drills and drill bits are used for drilling a variety materials in a variety of tasks, and in a variety of applications. Often, the material being drilled is sensitive and prone to damage if the drill operator were to make contact with the drill in certain areas of the material. For example, a delicate woodworking project may require heightened care by the drill operator to preserve delicate carvings and wood surface detail near the drill site. In addition, a surgeon working with a bone drill must take precautions against damaging nerves and tissue surrounding a drill site. However, due to the nature of a drill which often involves a drill bit rotating at a high speed, maintaining the necessary precision can prove difficult and many times a drill bit may slip and stray from the intended drilling site resulting in unintended and often undesirable consequences.

### SUMMARY

From the foregoing discussion, it should be apparent that a need exists for an apparatus, system, and method that retracts a drill bit relative to a drill. Beneficially, such an apparatus, system, and method would retract a drill bit when a drill bit slips or moves from a drilling site.

Accordingly, the present disclosure has been developed in response to the present state of the art, and in particular, in response to the problems and needs in the art that have not yet been fully solved by currently available drills and drill bits. Accordingly, the present invention has been developed to provide an apparatus, system, and method for retracting a drill bit relative to a drill that overcome many or all of the above-discussed shortcomings in the art.

According to one embodiment, an apparatus is provided for retracting a drill bit relative to a drill. The apparatus includes a drill, an electric motor positioned within the drill, a drill bit coupleable to the electric motor, a sensor mechanism in communication with the electric motor, a first engaging element fixedly coupled to the drill bit, a second engaging element movably coupled to the drill, and a bit disengaging element. In certain implementations, the sensor mechanism detects an increase in a rotational speed of the drill bit. The second engaging element moves into engagement with the first engaging element in a retracting mode triggered by the sensor mechanism detecting an increase in the rotational speed of the drill bit. Engagement between the first and second engaging elements causes the drill bit to retract relative to the drill. The bit disengaging element couples the drill bit to the electric motor in a non-retracting mode and decouples the drill bit from the electric motor in the retracting mode.

According to another embodiment, an apparatus is provided for retracting a drill bit relative to a drill including a drill a driving device within the drill, a drill bit coupleable to the driving device, a first engaging element coupled to the drill bit, a sensor in communication with the driving device, and a second engaging element coupled to the drill. The drill bit is rotatably drivable by the driving device. The sensor detects a change in a speed of the drill bit. The second engaging element engages with the first engaging element in response to the sensor detecting a change in the speed of the drill bit. The drill bit retracts relative to the drill in response to engagement between the second engaging element and the first engaging element. In some implementations, the apparatus further includes a bit disengaging element coupled to the driving device. The bit disengaging element is releasably coupled to the drill bit to couple the drill bit to the driving device. The bit disengaging element decouples the drill bit from the driving device in response to the sensor detecting a change in the speed of the drill bit.

In specific implementations of the apparatus, the first engaging element includes a pin and the second engaging element includes a plurality of threads. The second engaging element is movable to engage the pin with the plurality of threads. The plurality of threads may be tapered threads such that the speed of the drill bit slows and the drill bit retracts relative to the drill as the pin engages the tapered threads. In alternative implementations of the apparatus, the first engaging element includes a plurality of threads and the second engaging element includes a pin. In such implementations, the pin is movable into engagement with the plurality of threads to decrease the speed of the drill bit and retract the drill bit relative to the drill.

In some implementations of the apparatus, the first engaging element includes a first plurality of threads and the second engaging element includes a second plurality of threads. The first plurality of threads is movable into engagement with the second plurality of threads to retract the drill bit relative to the drill.

According to some implementations, the driving device is translationally moveable within the drill to retract the drill bit relative to the drill. The driving device may be translationally moveable along a track coupled to the drill.

In some implementations of the apparatus, the sensor detects an increase in the speed of the drill bit. The sensor may detect the change in speed of the drill bit by detecting a change in revolutions per minute (“RPM”) of the drill bit. Additionally, or alternatively, the sensor may detect the change in speed of the drill bit by detecting a change in amperage pull of the driving device.

According to another embodiment, a method for retracting a drill bit relative to a drill includes the steps to carry out the functions presented above with respect to the operation of the described apparatuses. In one embodiment, the method includes detecting a change in a speed of the drill bit. The method also includes engaging a first engaging element coupled to the drill bit with a second engaging element coupled to the drill in response to detecting a change in speed of the drill bit. Further, the method includes retracting the drill bit relative to the drill in response to the first engaging element engaging with the second engaging element.

In some implementations, the method includes disengaging the drill bit from the driving device in response to detecting a change in speed of the drill bit. In one implementation, the method includes reducing the speed of the drill bit in response to the first engaging element engaging with the second engaging element. In certain implementations, the first engaging element includes a pin and the second engaging element includes a plurality of threads. The second engaging element engages the pin with the plurality of threads. In some implementations, the first engaging element includes a plurality of threads and the second engaging element includes a pin. The pin engages with the plurality of threads to decrease the speed of the drill bit and retract the drill bit relative to the drill. In certain implementations, detecting a change in a speed of the drill bit includes detecting an increase in the speed of the drill bit. In one implementation, detecting a change in a speed of the drill bit includes detecting a change in revolutions per minute (“RPM”) of the drill bit. Furthermore, detecting a change in a speed of the drill bit may include detecting a change in amperage pull of the driving device.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the features, advantages, and characteristics of the subject matter described herein may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims, or may be learned by the practice of the subject matter as set forth hereinafter.

### BRIEF DESCRIPTION OF THE DRAWINGS

In order that the advantages of the subject matter may be readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1A is a schematic partial cross-sectional side view illustrating one embodiment of a drill apparatus;

FIG. 1B is a schematic partial cross-sectional side view of the drill apparatus of FIG. 1A in which a drill bit rotates in relation to a drill at a rate of speed;

FIG. 1C is a schematic partial cross-sectional side view of the drill apparatus of FIG. 1A in which a second engaging element is moved into engagement with a first engaging element;

FIG. 1D is a schematic partial cross-sectional side view of the drill apparatus of FIG. 1A in which the second engaging element is engaged with the first engaging element causing the drill bit to retract relative to the drill;

FIG. 2A is a schematic top plan of the drill apparatus of FIG. 1A;

FIG. 2B is a schematic top plan of the drill apparatus of FIG. 1A in which the second engaging element is moved into engagement with the first engaging element;

FIG. 3 is a schematic partial cross-sectional side view illustrating another embodiment of a drill apparatus;

FIG. 4 is a schematic partial cross-sectional side view illustrating yet another embodiment of a drill apparatus;

FIG. 5A is a schematic partial cross-sectional side view illustrating one embodiment of a drill apparatus having tapered threads;

FIG. 5B is a schematic partial cross-sectional side view of the drill apparatus of FIG. 5A in which a second engaging element is moved into engagement with a first engaging element;

FIG. 5C is a schematic partial cross-sectional side view of the drill apparatus of FIG. 5A in which the second engaging element is engaged with the first engaging element causing a drill bit to slow and retract relative to a drill;

FIG. 6 is a schematic partial cross-sectional side view illustrating one embodiment of a drill apparatus with a translationally moveable driving device;

FIG. 7A is a schematic partial cross-sectional side view illustrating another embodiment of a drill apparatus;

FIG. 7B is a schematic partial cross-sectional side view of the drill apparatus of FIG. 6A in which a second engaging element is moved into engagement with a first engaging element causing a drill bit to slow; and

FIG. 8 is a schematic flow chart diagram illustrating an embodiment of a method for retracting a drill bit.

### DETAILED DESCRIPTION

Reference throughout this specification to “one embodiment,” “an embodiment,” or similar language means that a particular feature, structure, or characteristic described in connection with the embodiment is included in at least one embodiment of the subject matter. Thus, appearances of the phrases “in one embodiment,” “in an embodiment,” and similar language throughout this specification may, but do not necessarily, all refer to the same embodiment.

Furthermore, the described features, structures, or characteristics of the subject matter described herein may be combined in any suitable manner in one or more embodiments. In the following description, numerous specific details are provided to provide a thorough understanding of embodiments of the subject matter. One skilled in the relevant art will recognize, however, that the disclosed subject matter may be practiced without one or more of the specific details, or with other methods, components, materials, and so forth. In other instances, well-known structures, materials, or operations are not shown or described in detail to avoid obscuring aspects of the disclosed subject matter.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

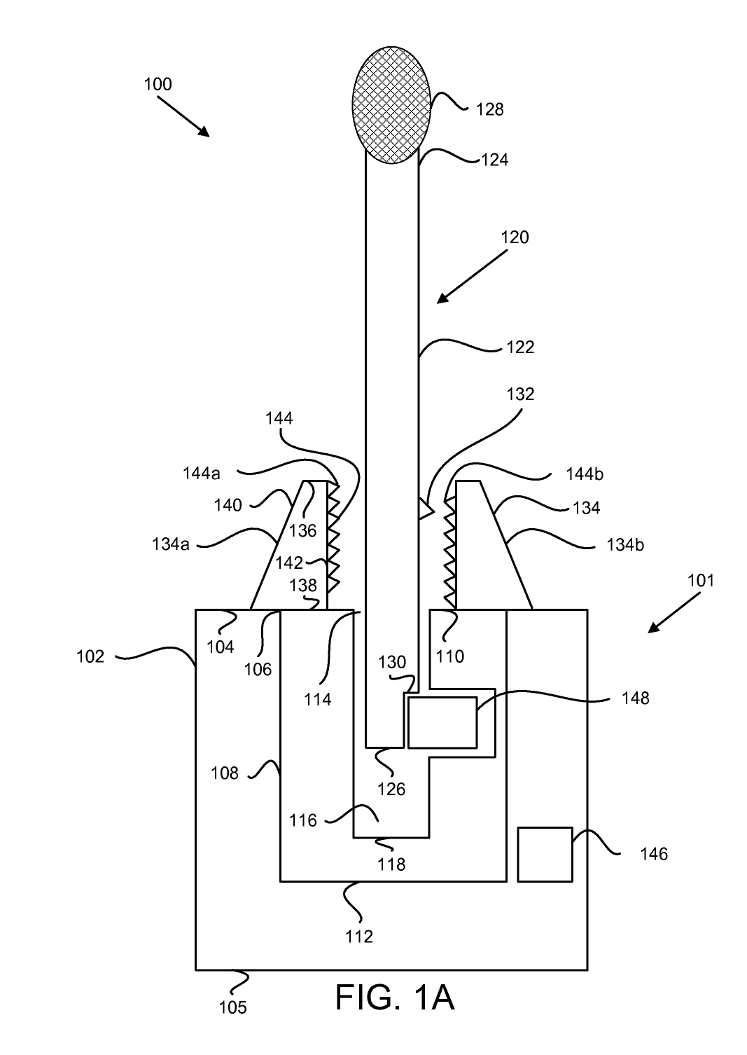

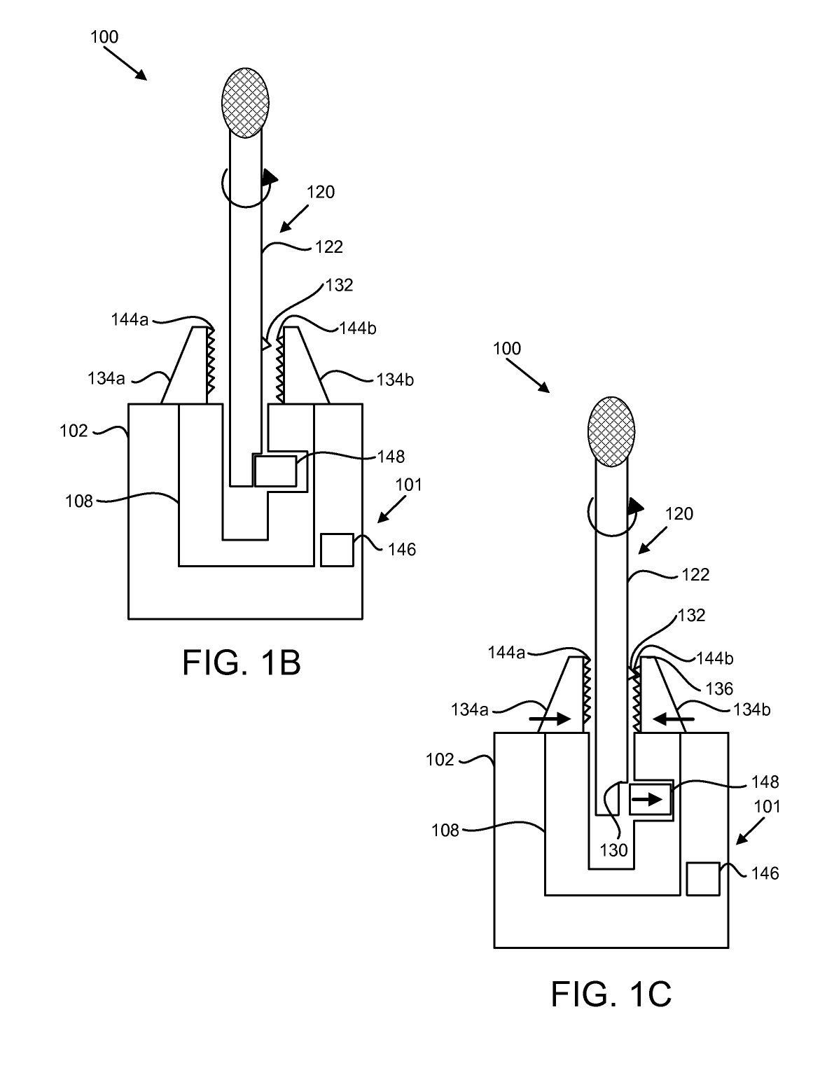

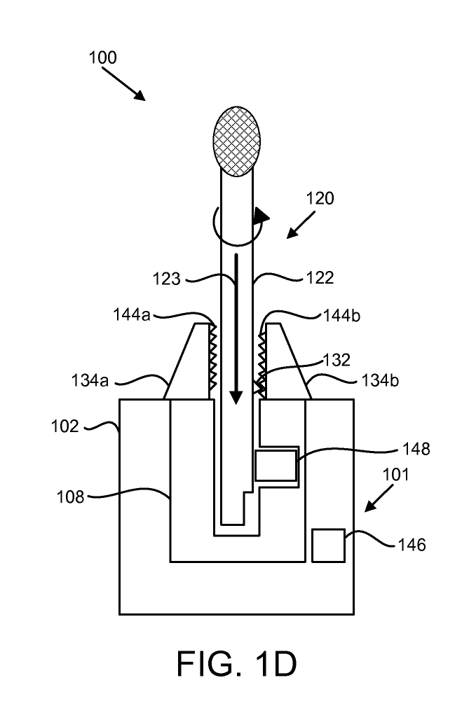

As illustrated in FIG. 1A, a drill apparatus 100 according to one embodiment includes a drill 101 that is engageable with a drill bit 120 and operable to rotate the drill bit 120. The drill bit 120 includes a first engaging element 132. The drill 101 includes a drill housing 102, a bit coupler 108, a second engaging element 134, a sensor mechanism 146, and a bit disengaging element 148.

The drill 101 may be a high-speed surgical drill system such as the Midas Rex® Legend® Pneumatic and Legend EHS™ drill systems. In other embodiments, the drill 101 may be embodied as part of other types of drills and drill systems. The drill housing 102 extends from a first end 104 to a second end 105 generally opposite the first end. The first end 104 includes an opening 106 through which the drill bit 120 is insertable. The drill housing 102 may be a portion of a drill handpiece, a portion of a drill system, and the like. The drill housing 102 may be an outer shell of the drill 101 or drill system. In one embodiment, the drill housing 102 is an internal frame to which an outer shell attaches. The drill housing 102 may be the body, or at least a portion of the body of the drill 101 and may provide rigid structure to the drill 101. The drill housing 102 at least partially encloses a driving device, such as a motor, and the bit coupler 108. The drill housing 102 may wrap around the driving device and bit coupler 108, allowing a drill operator to hold the drill apparatus 100 by grasping the drill housing 102.

The drill bit 120, in one embodiment, is coupled to the driving device by way of the bit coupler 108 that extends from a first end 110 to an opposing second end 112. In the illustrated embodiment, the bit coupler 108 has an opening 114 in the first end 110 that defines an open end of a cavity 116 defined within the bit coupler 108. The opening 114 is operable to allow a drill bit 120 to be received within the cavity 116 in the bit coupler 108. The bit coupler 108, in one embodiment, is configured to engage a drill bit 120 in the cavity 116 and rotate the drill bit 120 in relation to the drill housing 102. The cavity 116 has a first closed end 118 opposite the open end 114. Furthermore, the cavity 116 has a length sufficient to allow the drill bit 120 to retract as described in greater detail below.

The bit coupler 108 is rotatable within the drill housing 102. In one embodiment, the bit coupler 108 is operated and driven by the driving device positioned within the drill housing 102. In another embodiment, the driving device is positioned outside the drill housing 102 but is operationally coupled to the drill bit 120. The second end 112 of the bit coupler 108 may be coupled to a shaft or drive pinion powered by the driving device, which turns the shaft/drive pinion and drives the bit coupler 108.

Furthermore, the bit coupler 108 may comprise a drill attachment mechanism that is coupleable to a drill base unit. The drill base unit may house the driving device or house a drive shaft of the driving device. In one embodiment, the bit coupler 108 is a bur latch, drill bit chuck, or other mechanism to couple a drill bit 120 to a drill and/or driving device. The driving device may comprise a motor such as an electric motor or a pneumatic motor.

The drill bit 120 may include a generally cylindrical shaft 122 that extends between a first outer end 124 and a second inner end 126. The shaft 122 may also be a generally elongated shaft with a square, triangle, or flat cross-sectional shape. The drill bit 120 includes drilling element 128 coupled to the first outer end 124. The shaft 122 also may include a slot or notch 130 near the second end 126. In certain embodiments, the drill bit 120 may be embodied as one of various types of drill bits including, but not limited to, a surgical drill bit, a dental drill bit, a carpentry drill bit, and the like. For example, in one embodiment, the shaft 122 of the drill bit 120 includes helical flutes terminating in a point at the first end 124 of the shaft 122 as is known in the art.

In the depicted embodiment, the drilling element 128 is a grinding head for a surgical drill bit. In other embodiments, the drill bit 120 include various drilling elements of other types coupled to the first outer end 124 (e.g. dissection heads, boring heads, bur heads, and the like) without departing from the spirit of the present subject matter. Although the depicted drill bit 120 includes a separate filling element coupled to the shaft 122, in other embodiments, the first outer end 124 of the shaft 122 may include an integrated drilling element formed in a one-piece construction with the shaft 122. Alternatively, the drilling element 128 may extend along a length of the shaft 122.

In the depicted embodiment, the drill bit 120 may be driven by the driving device via the bit coupler 108 to rotate in relation to the drill housing 102. In certain drill embodiments, such as in high-speed surgical drills, the rotational speed of a drill bit may range from 200 to 75,000 rpm. In some dental drills, the rotational speed of a drill bit may exceed 500,000 rpm.

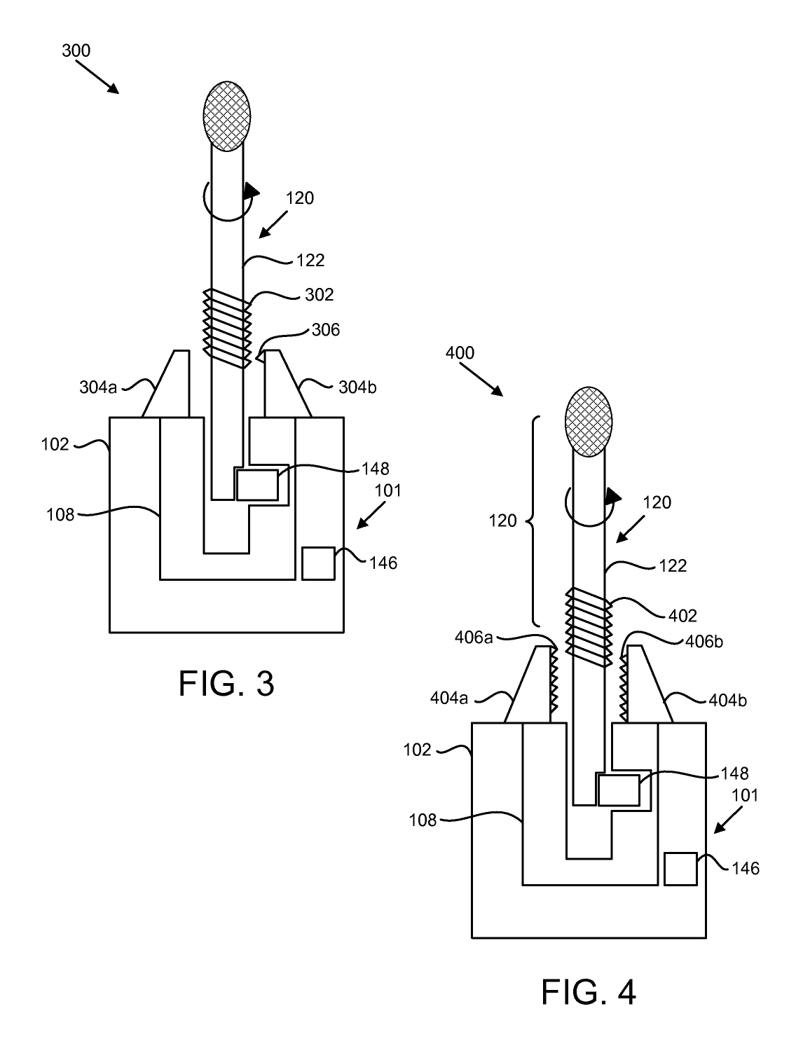

Referring again to FIG. 1A, a first engaging element 132 is coupled to the drill bit 120. In one embodiment, the first engaging element 132 is fixedly coupled to the drill bit 120. The first engaging element 132 is coupled to the shaft 122 at a location between the inner end 126 and the outer end 124. More specifically, in the depicted embodiment, the location of the first engaging element 132 on the shaft 122 is selected such that the first engaging element 132 is positioned between a second engaging element 134 when the drill bit 120 is engaged with the bit disengaging element 148. In the depicted embodiment, the first engaging element 132 is a pin, peg, or spike. In other embodiments, the first engaging element 132 is a single thread or portion of a thread. Although FIG. 1A shows the first engaging element 132 as a single element, the first engaging element 132 may comprise multiple elements such as a first pin or peg coupled to a point on one side of the shaft 122, and a second pin or peg coupled to a point on an opposite side of the shaft 122. FIGS. 3 and 4 show alternate embodiments of the first engaging element 132 and are discussed below.

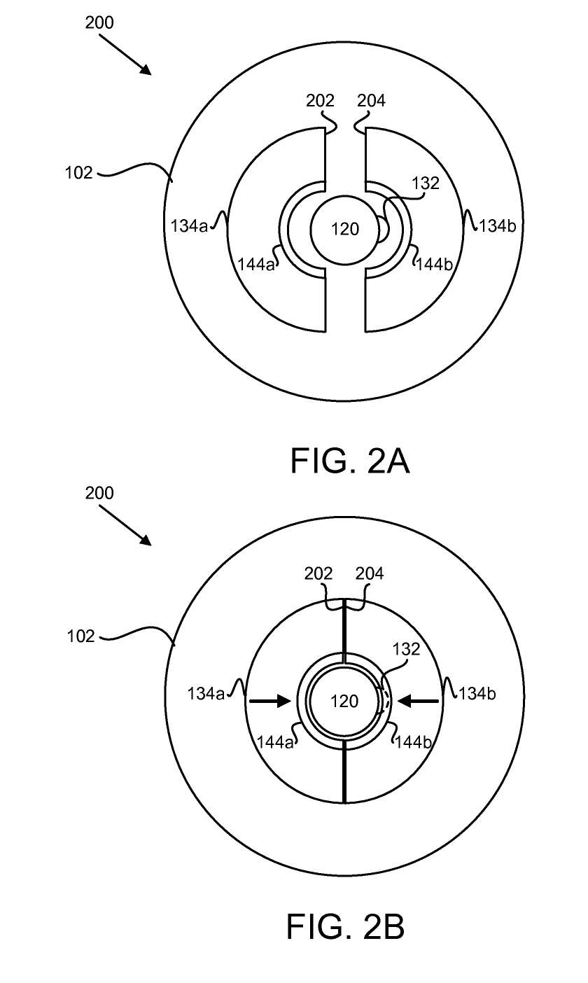

The second engaging element 134 is coupled to the drill housing 102 proximate to the first end 104 of the drill housing 102. In one embodiment, the second engaging element 134 is movably coupled to the drill housing 102. The second engaging element 134 extends from a first end 136 to a second end 138, and has an outside edge 140 and an inside edge 142. The inside edge 142 faces the drill bit 122 when engaged with the drill 101. In certain embodiments, the second engaging element 134 is embodied as at least two elements 134a, 134b that move toward and/or away from each other. In the depicted embodiment, the second engaging element 134 includes a plurality of threads 144 along the inside edge 142 of the second engaging element 134. The threads 144 may include multiple ribs that extend around the inside surface of the second engaging element 134, encircling the drill bit 120 (see FIG. 2A). FIG. 1A shows a partial cross section of the threads 144, depicting the rib of each thread 144 extending from the inside surface 142 of the second engaging element 134. FIGS. 3 and 4 show alternate embodiments of the second engaging element 134 and are discussed below.

The drill apparatus 100 is operable in a non-retracting mode and a retracting mode. As shown in FIG. 1A, in the non-retracting mode, the second engaging element 134 may be disengaged with the first engaging element 132. In the retracting mode, the second engaging element 134 moves into engagement with the first engaging element 132. The transition or switch from the non-retracting mode to the retracting mode can be triggered by a sensor 146 as described below. Referring to FIG. 2A, as stated above, the second engaging element 134 may be divided into two or more sections 134a, 134b. FIG. 2A depicts a first section 134a with a first side 204 and a second section 134b with a first side 208. Although the depicted embodiment shows the second engaging element 134 divided into two sections 134a, 134b, in other embodiments, the second engaging element 134 may be divided into more than two sections.

Referring back to FIG. 1A, in certain embodiments, the second engaging element sections 134a, 134b are movable toward each other to engage the pin of the first engaging element 132 with the plurality of threads 144. Referring to FIG. 2A, the first section 134a is moveable to engage the second section 134b such that the first side 204 of the first section 134a is configured to be adjacent to, or alternatively, in contact with the first side 208 of the second section 134b (see FIG. 2B).

As shown in FIG. 1A, the drill apparatus 100 includes a sensor 146 or sensor mechanism to detect a change in speed (e.g. an increase in speed) of the drill bit 120. An unanticipated increase in speed of the drill bit 120 during operation may be characteristic of the drill bit 120 encountering a lack of resistance as may be indicative of the drill bit 120 slipping off or moving away from a drilling surface. For example, a drill operator may be using the drill apparatus 100 to drill into bone and the drill may slip. As the drill bit 120 comes off the bone, the drill bit 120, without the resistance of the bone, may suddenly increase in speed. The sensor 146 is configured to detect this increase in speed. Therefore, in one embodiment, the sensor 146 detects an increase in the speed (e.g. rotational speed) of the drill bit 120.

The sensor 146 may detect the change in speed of the drill bit 120 in several ways. In one embodiment, the sensor 146 detects the change in speed of the drill bit 120 by detecting a change in revolutions per minute (“rpm”) of the drill bit 120. When the driving device is an electric motor, in certain embodiments, the sensor 146 interfaces with the electric motor to determine a change in the rpm of the drill bit 120. A current speed of the electric motor may, in certain conventional drills, provide an accurate indication of the current speed of the drill bit 120 in rpm. Therefore, in one embodiment, the sensor 146 determines the speed of the drill bit 120 by detecting the speed of the electric motor. For example, the sensor 146 may reference the current speed from the electric motor at a predetermined interval of time and sense a change in speed if the referenced speed differs from the previously referenced speed by a threshold amount.

In one embodiment, the sensor 146 detects the change in speed of the drill bit 120 by detecting a change in amperage pull of the driving device and/or electric motor. For example, the greater the resistance on the driving device/drill bit 120, the greater the amperage pull. If a drill operator is drilling into bone and the drill slips, as the drill bit 120 comes off the bone, the amperage pull of the driving device and/or electric motor, without the resistance of the bone, may decrease suddenly. In a drill apparatus 100 in which the driving device is a pneumatically-driven motor drivable by pressurized gas, the sensor 146 may detect the change in speed by detecting a change in pressure of the pressurized gas and/or change in flow rate of the pressurized gas driving the motor. For example, when the drill bit 120 increases in speed, the sensor may detect a sudden change in gas pressure (e.g., decrease in gas pressure) or gas flow rate (e.g., increase in gas flow rate). In one embodiment, the sensor 146 detects a change in gas pressure from a pressure meter/pressure gauge coupled to a gas pressure source and/or pressure control unit. For example, the sensor 146 may be in communication with the pressure gauge on the pressure control unit. In one embodiment, the sensor 146 includes and/or is in communication with a gas flow rate sensor to detect a change in the gas flow rate.

The sensor 146 may be configured to differentiate between the standard acceleration of the drill bit 120 as the drill operator begins drilling and the increase in speed of the drill bit 120 when the drill bit 102 slips off of the drilling surface. In one embodiment, the sensor 146 actively detects changes in a speed of a drill bit 120 only after the drill apparatus 100 has been operating for a predetermined period of time. In another embodiment, to distinguish between drill operator controlled speed changes and speed changes caused by drill bit 120 slippage, the sensor 146 triggers the retracting mode when the drill bit 120 increases in speed, but the amount of power supplied to the driving device, as controlled by the drill operator, remains the same.

The sensor 146 may be in speed detecting communication with the driving device and/or motor. The sensor 146 may reside in the drill housing 102 as shown in FIG. 1A. Alternatively, the sensor 146 may reside outside of the drill housing 102 but in communication with the driving device and/or motor. The sensor 146, in response to detecting a change in speed, may signal the drill apparatus 100 to switch from the non-retracting mode to the retracting mode as is described in greater detail below.

Referring again to FIG. 1A, a bit disengaging element 148 is coupled to the driving device via the bit coupler 108. The bit disengaging element 148 is releasably coupled to the drill bit 120 to couple the drill bit 120 to the bit coupler 108. The bit disengaging element 148 decouples the drill bit 120 from the bit coupler 108 in response to the sensor 146 detecting a change in the speed of the drill bit 120 (see FIG. 1C) and the drill apparatus 100 being operated in the retracting mode. In one embodiment, the bit disengaging element 148 couples the drill bit 120 to the bit coupler 108/motor in the non-retracting mode and decouples the drill bit 120 from the bit coupler 108/motor in the retracting mode. The bit disengaging element 148, as depicted in FIG. 1A, may adjoin the slot 130 in the shaft of the drill bit 120 to releasably couple the drill bit 120 to the bit coupler 108. The bit disengaging element 148 may engage the drill bit 120 such that the drill bit 120 and the bit coupler 108 co-rotate. Although a single bit disengaging element 148 is depicted in FIG. 1A, multiple bit disengaging elements 148 may also be used in other embodiments to releasably couple the drill bit 120 to the driving device via the bit coupler 108.

During operation of the drill apparatus 100 in the non-retracting mode, a drill operator may be drilling on or near a sensitive drilling surface. For example, a spinal surgeon may be drilling in bone with delicate nerves and tissues in close proximity. As the drill operator puts pressure on the drill, the drill bit 120 may slip periodically, which may place the drill bit 120 in contact with sensitive areas near the drill site. With the drill bit 120 still rotating, the drill bit 120 may cause damage to the sensitive area. Further, as the drill bit 120 slips, the drill bit 120 may increase in speed as resistance to the rotation of the drill bit 120 is removed. The drill apparatus 100 may detect this increase in speed and retract the drill bit 120 in response to the increase in speed. Consequently, the retracted drill bit 120, being removed from sensitive areas, is less likely to cause damage to the sensitive areas around the drill site.

FIG. 1B shows the drill bit 120 rotating at a rate of speed. FIG. 1C shows the drill apparatus 100 of FIG. 1A operating in the retracting mode. In the retracting mode, the second engaging element 134 moves into engagement with the first engaging element 132. The sensor 146 may detect the increase in speed of the drill bit 120. In response to detecting the increase in speed, the sensor 146 may signal the bit disengaging element 148 to disengage the drill bit 120. The sensor 146 may also signal the second engaging element 134 to engage the first engaging element 132. In one embodiment, the sensor 146 signals at least one actuator that moves the bit disengaging element 148 and the second engaging element 134. For example, the actuator may cause the second engaging element 134 to enclose the drill bit 120 and that causes the bit disengaging element 148 to retract from the slot 130 in the shaft 122 and disengage the drill bit 120. FIG. 2B shows one embodiment of the second engaging element 134 with two sections 134a, 134b in which each section of the second engaging element 134 move and enclose the drill bit 120, engaging the first engaging element 132.

As depicted in FIG. 1C, in the retracting mode, the second engaging element 134 engages the pin 132 with the plurality of threads 144. As depicted, the pin 132 lines up with the threads 144 of the second engaging element 134 in proximity to the first end 136 of the second engaging element 134.

As shown in FIG. 1D, the rotational momentum of the drill bit 120 causes the first engaging element 132 to track along the path defined between adjacent threads in a spiral motion. The continuous rotation and the engagement between the first engaging element 132 and the second engaging element 134 results in the drill bit 120 moving in the direction indicated by the directional arrow 123. The threads 144 of the second engaging element 134 may be directionally oriented such that the rotating motion of the drill bit 120 causes the drill bit 120 to retract toward the drill housing 102 into the cavity 116 of the bit coupler 108. As a result, the drill bit 120 retracts and is removed from sensitive surfaces near the drilling site. Furthermore, in certain embodiments, the first engaging element 132 engaging with the second engaging element 134 also reduces the speed of the drill bit 120 as it retracts. In certain embodiments the cavity 116 may be of a depth sufficient to receive the drill bit 120, including the drilling element 128, within the cavity 116. In such an embodiment the drill bit 120 may be completely received within the cavity 116 such that the rotating drill bit 120 does not contact sensitive surfaces near the drilling site.

Referring to FIG. 3, another embodiment of the drill apparatus 300 includes a drill 101 that is engageable with a drill bit 120 and operable to rotate the drill bit 120. The drill 101 includes a drill housing 102, a bit coupler 108, and a bit disengaging element 148 that are similar to the like features of the drill apparatus 100 of FIG. 1A. Furthermore, the drill apparatus 300 includes a first engaging element 302 and a second engaging element 304 with a pin 306. The drill apparatus 300 is shown in the non-retracting mode but the drill apparatus 300 may also be configured to transition to the retracting mode similar to the drill apparatus 100 in FIG. 1A. Specifically, the second engaging element 304 may be similarly moveably coupled to the drill housing 102 and triggered to engage the first engaging element 302 by the sensor 146 in response to the sensor 146 detecting a change in speed of the drill bit 120 as in the drill apparatus 100 of FIG. 1A.

However, in the embodiment depicted in FIG. 3, the first engaging element 302 comprises a plurality of threads and the second engaging element 304 includes a pin 306. The plurality of threads 306 may wrap around the shaft of the drill bit 120. The pin 306, adjoining the first side of the second engaging element 304, is movable into engagement with the plurality of threads 302 to retract the drill bit 120 relative to the drill 101. Similar to the drill apparatus 100 of FIG. 1A in which the plurality of threads 144 reside on the second engaging element 134, the threads 302 are oriented such that the rotational motion of the drill bit 120 causes the drill bit 120 to retract as the rotational momentum of the drill bit 120 causes the pin 306 to track along the path defined between adjacent threads on the drill bit 120 in a spiral motion. The continuous rotation and the engagement between the pin 306 and the threads 302 results in the drill bit 120 retracting in a similar manner of the drill apparatus 100 as shown in FIG. 1D.

Referring to FIG. 4, another embodiment of a drill apparatus 400 also includes a drill 101 that is engageable with a drill bit 120 and operable to rotate the drill bit 120. The drill 101 includes a includes a drill housing 102, a bit coupler 108, a drill bit 120, and a bit disengaging element 148 that are similar to the like features of the drill apparatus 100 of FIG. 1A. However, in the depicted embodiment, both engaging elements 402,404 include threads. Specifically, the first engaging element comprises a first plurality of threads 402 and the second engaging element 404 includes a second plurality of threads 406. The first plurality of threads 402 is movable into engagement with the second plurality of threads 406 in the retracting mode to retract the drill bit 120 relative to the drill 101.

The second engaging element 404 may be similarly moveably coupled to the drill housing 102 and triggered to engage the first engaging element 402 by the sensor 146 in response to the sensor 146 detecting a change in speed of the drill bit 120 as in the retracting mode of the drill apparatus 100 of FIG. 1A.

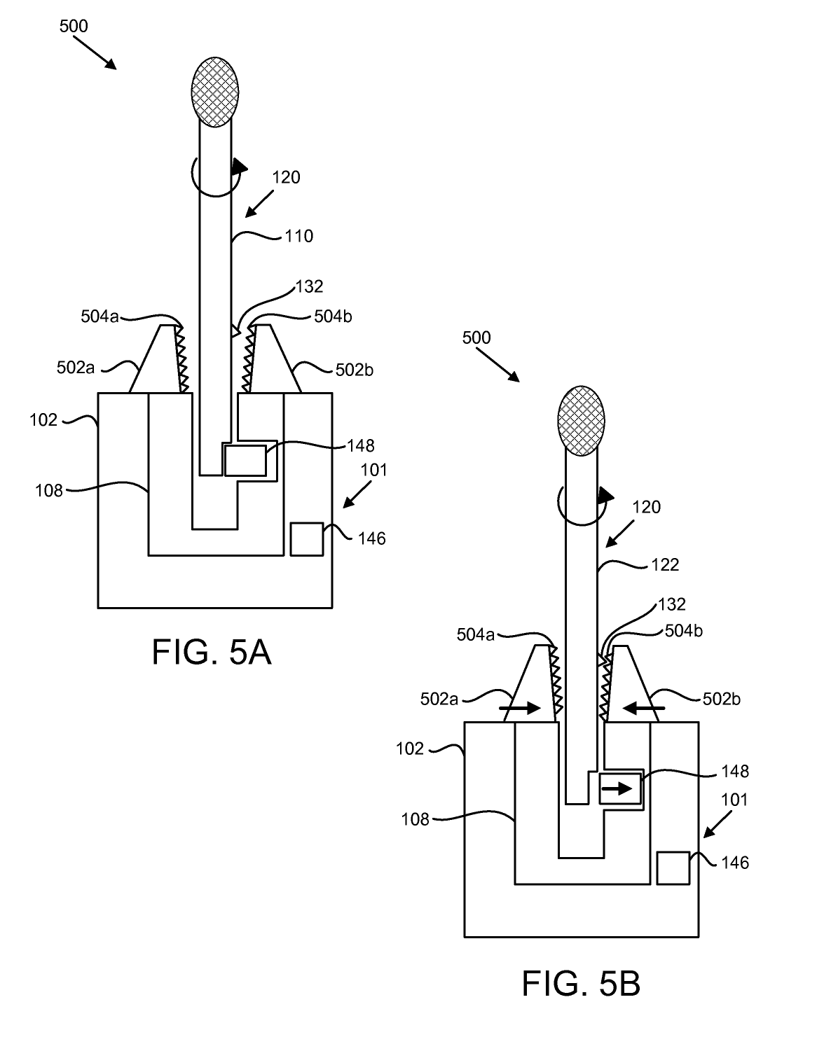

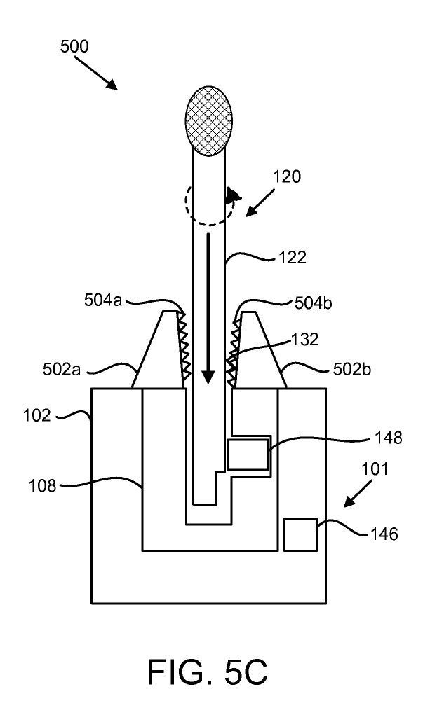

FIG. 5A illustrates one embodiment of a drill apparatus 500 having tapered threads. The drill apparatus 500 includes a drill bit 120 and a drill 101 with a drill housing 102, a bit coupler 108, a first engaging element 132, and a bit disengaging element 148 that are similar to the like features of the drill apparatus 100 of FIG. 1A. Furthermore, the drill apparatus 500 includes a second engaging element 502 with tapered threads 504. The drill apparatus 500 is shown in the non-retracting mode. However, the drill apparatus 500 is also operable in the retracting mode in which the second engaging element 502 may be similarly moveably coupled to the drill housing 102 and triggered to engage the first engaging element 132 by the sensor 146 in response to the sensor 146 detecting a change in speed of the drill bit 120 as in the drill apparatus 100 of FIG. 1A. The tapered threads 504 may be tapered such that the second engaging element 504, in the retracting mode, narrows approaching the drill housing 102. Although the first engaging element 132 is shown as a pin, the first engaging element 132 may also comprise the plurality of threads 302 as depicted in FIG. 3 or the other embodiments of the first engaging element discussed above.

FIG. 5B shows the drill apparatus 500 of FIG. 5A moving into the retracting mode in which the second engaging element 502 is moved into engagement with the first engaging element 132. FIG. 5B shows the pin of the first engaging element 132 engage with the tapered threads 504 of the second engaging element 402.

FIG. 5C shows the second engaging element 502 engaged with the first engaging element 132 causing the drill bit 120 to slow and retract relative to the drill 101. The speed of the drill bit 120 slows and the drill bit 120 retracts relative to the drill 101 as the pin 132 engages the tapered threads 504. Specifically, as the drill bit 120 retracts toward the drill housing 102, the tapered threads 504 exert pressure on the pin 132 and the shaft of the drill bit 120, slowing the drill bit 120 as it retracts.

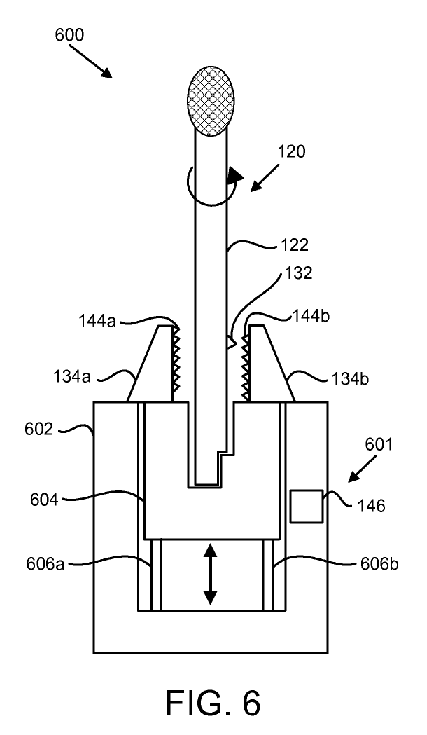

Referring to FIG. 6 one embodiment of a drill apparatus 600 with a translationally moveable driving device includes a drill bit 120 and a drill 601 with a drill housing 602, a bit coupler 604, a first engaging element 132, a second engaging element 134 with threads 144, and a sensor 146. The drill bit 120, the first engaging element 132, the second engaging element 134 with threads 144 and the sensor 146 may be similar to the like features of the drill apparatus 100 of FIG. 1A. The second engaging element 134 may be similarly moveably coupled to the drill housing 602 and triggered, in the retracting mode, to engage the first engaging element 132 by the sensor 146 in response to the sensor 146 detecting a change in speed of the drill bit 120 as in the drill apparatus 100 of FIG. 1A.

However, the drill housing 602 is configured to house a translationally moveable driving device and/or bit coupler 604. Specifically, the driving device and/or bit coupler 604 is translationally moveable within the drill housing 602 to retract the drill bit 120 relative to the drill 601. In the depicted embodiment, the drill bit 120 remains engaged in the bit coupler 604 during the retracting mode. The driving device and/or the bit coupler 604 may retract with the drill bit 120 when the first engaging element 132 engages the second engaging element 134. In the depicted embodiment, the driving device and/or bit coupler 604 is translationally moveable along a track 606 coupled to the drill housing 602.

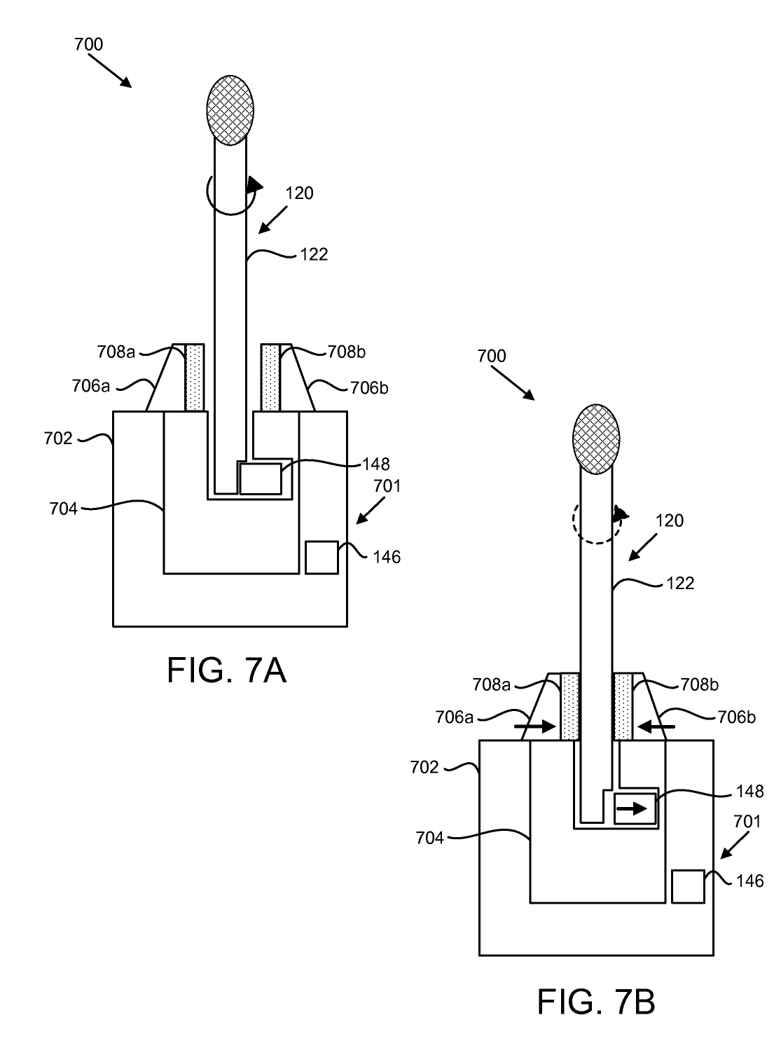

Referring to FIG. 7A, another embodiment of a drill apparatus 700 includes a drill bit 120 and a drill 701 with a drill housing 702, a bit coupler 704, a slowing mechanism 706 with a slowing element 708, a sensor 146, and a bit disengaging element 148. The drill bit 120, the sensor 146 and the bit disengaging element 148 may be similar to the like features of FIG. 1A. Furthermore, the slowing mechanism 706 may be similarly moveably coupled to the drill housing 702 and triggered by the sensor 146 in response to the sensor 146 detecting a change in speed of the drill bit 120 as the second engaging element 134 in the drill apparatus 100 of FIG. 1A.

However, in the embodiment depicted in FIG. 7A, the drill bit 120 does not retract relative to the drill 701. Specifically, the slowing mechanism 706 engages the drill bit shaft 120 in response to a signal from the sensor 146. The drill bit 120 slows in response to the slowing mechanism 706 engaging the drill bit shaft 122 with the slowing element 708 coupled to the slowing mechanism 706. Similar to the second engaging element 134 of the drill apparatus 100 of FIG. 1A, the slowing mechanism 706 may be divided into two or more sections 706a, 706b that are configured to move toward each other to engage the drill bit 120.

FIG. 7B shows the drill apparatus 700 of FIG. 7A in which the slowing mechanism 706 is engaged with the shaft 122 causing the drill bit 120 to slow. The slowing element 708 applies pressure to the shaft of the drill bit 120, causing the drill bit 120 to slow. The slowing element 708 may comprise a high-friction material to facilitate the slowing of the drill bit 120. For example, the slowing element 708 may comprise rubber pads. As the drill bit 120 slows in response to the change in speed, the drill bit 120 is less likely to cause damage to sensitive surfaces near the drilling site than would a drill bit 120 at full speed. In one embodiment, the bit disengaging element 148 disengages the drill bit 120 as the slowing element 708 applies pressure to the shaft of the drill bit 120. The bit disengaging element 148 may disengage the drill bit 120 prior to or substantially concurrent in time with the slowing element 708 engaging the drill bit 120.

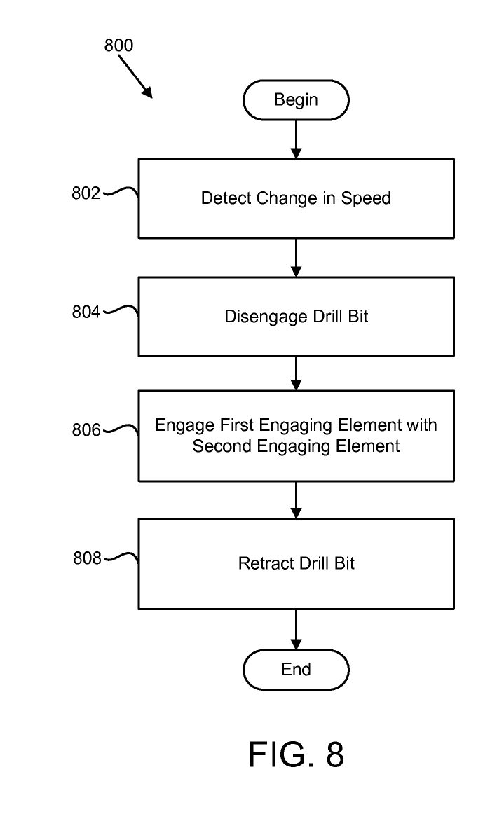

FIG. 8 is an embodiment of a method 800 for retracting a drill bit 120 relative to a drill 101. The method 800 begins and the sensor 146 detects 802 a change in a speed of the drill bit 120. The sensor 146 may detect an increase in a speed of the drill bit 120 as for example, the drill bit 120 slips from a drilling surface.

Next, the bit disengaging element 148 disengages 804 the drill bit 120 from the bit coupler 108. The bit disengaging element 148 may disengage in response to a signal from the sensor 146. For example, the sensor 146 may signal an actuator that translates the signal into movement and moves the bit disengaging element 148 from the slot 130 in the shaft 122.

The first engaging element 132 engages 806 with the second engaging element 134 in response to a signal from the sensor 146. For example, the sensor 146 may signal an actuator that translates the signal into movement and moves the second engaging element 134 to enclose the drill bit 120 and engage the first engaging element 132. Next, the engagement between the first engaging element 132 and the second engaging element 134 causes the drill bit 120 to retract 808 relative to the drill 101. Then the method 800 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for retracting a drill bit relative to a drill, the apparatus comprising:
a drill;
an electric motor positioned within the drill;
a drill bit coupleable to the electric motor;
a sensor mechanism in communication with the electric motor, the sensor mechanism being configured to detect an increase in a rotational speed of the drill bit;
a first engaging element fixedly coupled to the drill bit;
a second engaging element movably coupled to the drill, the second engaging element being configured to move into engagement with the first engaging element in a retracting mode triggered by the sensor mechanism detecting an increase in the rotational speed of the drill bit, wherein engagement between the first and second engaging elements causes the drill bit to retract relative to the drill; and
bit disengaging element coupled to the electric motor and releasably coupled to the drill bit, the bit disengaging element coupling the drill bit to the electric motor in a non-retracting mode and decoupling the drill bit from the electric motor in the retracting mode.

2. An apparatus for retracting a drill bit relative to a drill, the apparatus comprising:
a drill;
a driving device within the drill;
a drill bit coupleable to the driving device, the drill bit being rotatably drivable by the driving device;
a first engaging element coupled to the drill bit;
a sensor in communication with the driving device, the sensor being configured to detect a change in a speed of the drill bit; and
a second engaging element coupled to the drill, the second engaging element being configured to engage with the first engaging element in response to the sensor detecting a change in the speed of the drill bit, wherein the drill bit retracts relative to the drill in response to engagement between the second engaging element and the first engaging element.

3. The apparatus of claim 2, further comprising a bit disengaging element coupled to the driving device, the bit disengaging element being releasably coupled to the drill bit to couple the drill bit to the driving device, wherein the bit disengaging element is configured to decouple the drill bit from the driving device in response to the sensor detecting a change in the speed of the drill bit.

4. The apparatus of claim 2, wherein the first engaging element comprises a pin and the second engaging element comprises a plurality of threads, and wherein the second engaging element is movable to engage the pin with the plurality of threads.

5. The apparatus of claim 4, wherein the plurality of threads are tapered threads and wherein the speed of the drill bit slows and the drill bit retracts relative to the drill as the pin engages the tapered threads.

6. The apparatus of claim 2, wherein the first engaging element comprises a plurality of threads and the second engaging element comprises a pin, and wherein the pin is movable into engagement with the plurality of threads to decrease the speed of the drill bit and retract the drill bit relative to the drill.

7. The apparatus of claim 2, wherein the first engaging element comprises a first plurality of threads and the second engaging element comprises a second plurality of threads, and wherein the first plurality of threads is movable into engagement with the second plurality of threads to retract the drill bit relative to the drill.

8. The apparatus of claim 2, wherein the driving device is translationally moveable within the drill to retract the drill bit relative to the drill.

9. The apparatus of claim 8, wherein the driving device is translationally moveable along a track coupled to the drill.

10. The apparatus of claim 2, wherein the sensor is configured to detect an increase in the speed of the drill bit.

11. The apparatus of claim 2, wherein the sensor is configured to detect the change in speed of the drill bit by detecting a change in revolutions per minute (“RPM”) of the drill bit.

12. The apparatus of claim 2, wherein the sensor is configured to detect the change in speed of the drill bit by detecting a change in amperage pull of the driving device.

13. The apparatus of claim 2, wherein the driving device is drivable by pressurized gas, the sensor configured to detect the change in speed of the drill bit by detecting at least one of a change in pressure of the pressurized gas and a change in flow rate of the pressurized gas.

14. A method for retracting a drill bit, the drill bit being coupleable with a driving device within the drill to rotatably drive the drill bit, the method comprising:
detecting a change in a speed of the drill bit;
engaging a first engaging element coupled to the drill bit with a second engaging element coupled to the drill in response to detecting a change in speed of the drill bit; and
retracting the drill bit relative to the drill in response to the first engaging element engaging with the second engaging element.

15. The method of claim 14, further comprising disengaging the drill bit from the driving device in response to detecting a change in speed of the drill bit.

16. The method of claim 14, further comprising reducing the speed of the drill bit in response to the first engaging element engaging with the second engaging element.

17. The method of claim 14, wherein the first engaging element comprises a pin and the second engaging element comprises a plurality of threads, and wherein the second engaging element engages the pin with the plurality of threads.

18. The method of claim 14, wherein the first engaging element comprises a plurality of threads and the second engaging element comprises a pin, and wherein the pin engages with the plurality of threads to decrease the speed of the drill bit and retract the drill bit relative to the drill.

19. The method of claim 14, wherein detecting a change in a speed of the drill bit comprises detecting a change in revolutions per minute (“RPM”) of the drill bit.

20. The method of claim 14, wherein detecting a change in a speed of the drill bit comprises detecting a change in amperage pull of the driving device.
